(19) United States
(12) Patent Application Publication
(10) Pub. No.: US 2017/0051528 A1
(43) Pub. Date: Feb. 23, 2017

(54) FENCE SPREADER

(71) Applicant: Styx Solutions Limited, Christchurch (NZ)

(72) Inventors: Rex Stuart MUNRO, Kaiapoi (NZ); Darryn Forbes ROSS, Christchurch (NZ)

(73) Assignee: Styx Solutions Limited, Christchurch (NZ)

(21) Appl. No.: 15/118,677

(22) PCT Filed: Feb. 11, 2015
(86) PCT No.: PCT/IB2015/051038

§ 371 Date: Aug. 12, 2016

(30) Foreign Application Priority Data
Feb. 13, 2014 (NZ) 621223

(51) Int. Cl. E04H 17/12; A01K 3/00; E04H 17/24; E04H 17/04; E04H 17/08

(52) U.S. Cl. CPC E04H 17/12; E04H 17/04; E04H 17/08; E04H 17/24; A01K 3/005

(57) ABSTRACT

A fence spreader (10) includes an elongated support member (12) having a first face (14) and a second face (16), wherein the first face and the second face are located on opposite sides of the support member. A plurality of receiving grooves (18) across each said first and second faces are spaced along the length of the support member. Each receiving groove (18) is configured to hold a fence wire in a tight or snap fit, and the receiving grooves are configured such that, in use, adjacent fence wires are positioned on opposite sides of the fence spreader (10).

### TECHNICAL FIELD

The present invention relates to an improved design for a fence spreader, for use with wire fences.

### BACKGROUND ART

Any discussion of the prior art throughout the specification is not an admission that such prior art is widely known or forms part of the common general knowledge in the field.

A common design of agricultural fence is a wire fence, in which posts are driven or inserted into the ground at intervals, and a number of vertically spaced steel wires are strung along the fence line, connected to each post. Due to the sometimes considerable distance between adjacent posts, it is desirable to maintain separation of the wires where they may sag or be stretched by stock. Fence spreaders are installed at spaced intervals between adjacent posts in order to maintain the vertical separation of the wires; they also spread the force applied by stock on one wire across all wires, reducing the risk of wire breakage.

Fence spreader designs may be as simple as manually attaching or clipping each wire to a thin metal or wooden post. Often the means of attaching each wire to the spreader is twisting metal clips around the wire and post; this process can be time consuming, difficult to carry out, and/or require the use of tools.

More complex designs have been suggested which aim to decrease the amount of time spent installing the spreaders. WO 2005/108718 A1 and AU-B-23237/95 each describe fence spacers which include a support with a substantially U-shaped cross-section. Fence wires are inserted into slots spaced along the length of the support on the closed side of the U-shaped channel, and a locking pin is axially inserted between the inserted wires and the closed side of the U-shaped channel, holding the wires in place. Spacers of this design may decrease installation time over past simpler designs, but are comprised of multiple components, and thus are relatively expensive to produce. Spreaders are used in very large quantities, and therefore need to be inexpensive to manufacture.

There is a need for a low-cost, easy-to-install fence spreader. The object of the present invention is to overcome or mitigate at least one of the deficiencies described above, and/or provide the consumer with a useful choice.

### DISCLOSURE OF INVENTION

The present invention provides a fence spreader which includes:
an elongated support member having a first face and a second face, wherein the first face and the second face are located on opposite sides of the support member;
a plurality of receiving grooves across each said first and second faces and spaced along the length of the support member;
wherein each receiving groove is configured to hold a fence wire in a tight or snap fit; and
wherein the receiving grooves are configured such that, in use, adjacent fence wires are positioned on opposite sides of the fence spreader.

Preferably each receiving groove is located on an opposite face to the immediately adjacent receiving grooves. Alternatively, receiving grooves are located in pairs, one on the first face and one on the second face, along the length of the support member.

Preferably, each receiving groove is formed between a pair of projections. Preferably a reinforcing rib extends between adjacent pairs of projections the length of the elongated support member. Preferably each projection extends further than the outside edge of said reinforcing rib.

Alternatively, each receiving groove is formed as a recess in the first or second face.

Preferably, a width of each receiving groove is approximately equal to the diameter of a fence wire. The width of the receiving groove is defined as being the vertical height of the receiving groove when the fence spreader is in a vertical position. Alternatively, the width of each receiving groove narrows closer to the support member. In a preferred form, the receiving groove includes at least one constricted section and at least one expanded section, configured such that a length of wire may be held in a snap fit in the expanded section by the constricted section. Most preferably, the receiving groove includes bevelled leading edges. In a highly preferred form, each receiving groove is configured to receive more than one diameter of wire.

Preferably, the fence spreader further includes one or more secondary receiving grooves which are configured to receive barbed wire. Preferably said secondary receiving grooves are located directly below the topmost and third from top receiving grooves. Alternatively, said secondary receiving grooves are the topmost and third from top receiving grooves. In a highly preferred embodiment, the secondary receiving grooves include a secondary constricted section and a secondary expanded section such that a length of barbed wire is held in the secondary expanded section by the secondary constricted section. Preferably the secondary contracted section includes a dimple that projects into the secondary contracted section.

Preferably the fence spreader is constructed from an electrically insulating material. More preferably the fence spreader is constructed from high-density polyethylene (HDPE). Alternatively, the receiving grooves are electrically insulated.

Preferably the fence spreader further includes one or more outriggers. Preferably the or each outrigger includes an elongated portion with a connecting portion at one end and a first receiving portion at the other end. Preferably the outrigger further includes a second receiving portion part way along the elongated portion. Most preferably, the outrigger is detachable from the fence spreader. Most preferably the or each reinforcing rib includes a lug which engages with the connecting portion of the outrigger. Preferably the outrigger is constructed from electrically insulating material. Alternatively, the first, receiving portion, and second receiving portion if present, is electrically insulated.

Preferably the fence spreader further includes a spike, configured for insertion into the ground. The fence spreader may also further include a tread in plate.

In use, adjacent wires of the wire fence are located in receiving grooves on opposite faces of the support member.

The present invention also provides a method for installing a fence spreader as previously described, wherein said method includes the steps of:
a) threading the fence spreader through a wire fence such that adjacent fence wires are positioned on opposite sides of the fence spreader; and
b) positioning each wire into a receiving groove such that each wire is held in a tight or snap fit.

Preferably the method includes the steps of:
a) threading the fence spreader through a wire fence such that adjacent fence wires are positioned on opposite sides of the fence spreader and the length of the receiving grooves are at 90° to the length of the fence wires; and
b) twisting the fence spreader axially such that each wire is positioned, through the twisting motion, into a receiving groove such that the wire is held in a tight or snap fit.

Preferably the method further includes the step of:
c) after the wires are positioned within the receiving grooves, connecting one or more outriggers to the fence spreader, and positioning tape, braid, wire, or similar electrifiable length of fencing material within the first or second receiving portion of the or each outrigger.

### BRIEF DESCRIPTION OF DRAWINGS

By way of example only, preferred embodiments of the present invention are described in detail below with reference to the accompanying drawings, in which:

FIG. 1 is a side view of the most preferred embodiment of the fence spreader;

FIG. 1a is a perspective view of a portion of the fence spreader shown in FIG. 1;

FIG. 2 is a side view of a portion of the fence spreader;

FIGS. 3a, 3b, 3c show other, non-limiting, configurations of the receiving grooves;

FIG. 4 is a side view of secondary receiving grooves configured to receive barbed wire;

FIG. 5 shows a side view of the outrigger;

FIG. 5a shows a top view of the outrigger shown in FIG. 5;

FIG. 6 shows a detailed side view of the L-shaped lug on the fence spreader;

FIG. 7 is a diagrammatic side view of the fence spreader as installed on a wire fence.

### BEST MODE FOR CARRYING OUT THE INVENTION

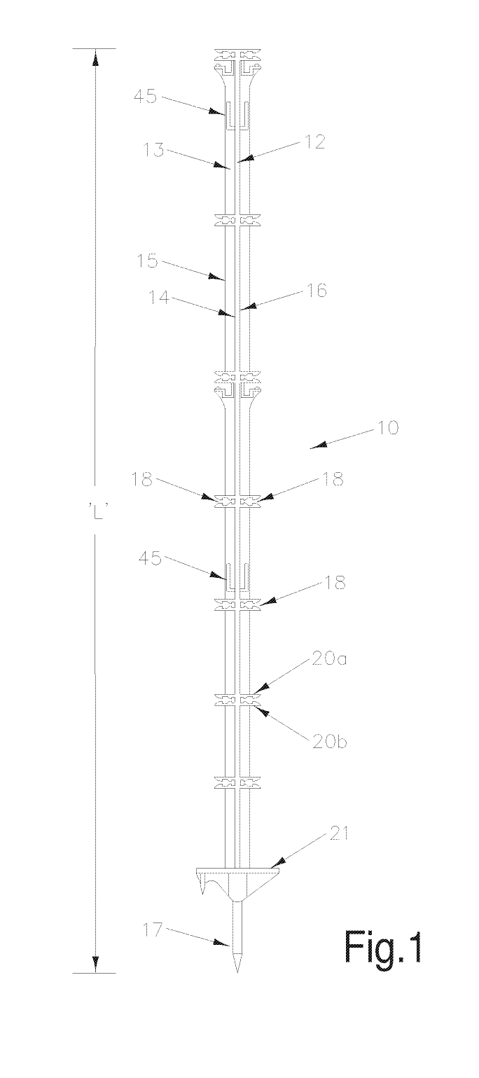

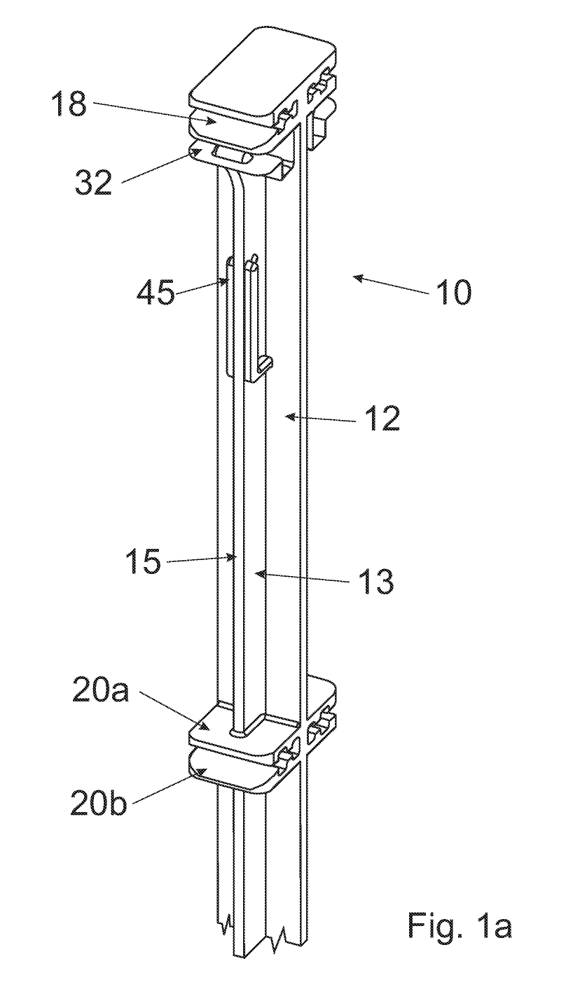

The most preferred embodiment of the invention is shown in FIG. 1. The fence spreader (10) includes an elongated support member (12) that provides a first face (14) and a second face (16) located on opposing sides of the support member (12).

The length (L) of the support member (12) is approximately equal to the distance from the top wire of a fence to the bottom wire on the fence, however may be longer than this. In the most preferred form, the length (L) of the support member (12) is approximately equal to the distance from the top wire of the fence to the ground, and more preferably includes a spike (17) to be inserted into the ground. A tread-in plate (21) is located above the spike (17), to aid in pushing the fence spreader into the ground. For some applications, it is not necessary to anchor the spreader to the ground, and the tread-in plate (21) and the spike (17) can be omitted.

Extending at right angles from each of the first face (14) and the second face (16) is a reinforcing rib (13) that extends along the length (L) of the support member (12) between adjacent pairs of projections (the projections are discussed below). The reinforcing rib (13) may extend fully or partially down the length (L) of the support member, but in the most preferred embodiment extends down the entire length. The reinforcing rib (13) provides strength to the fence spreader, in particular to prevent the elongated support member from excessive bending.

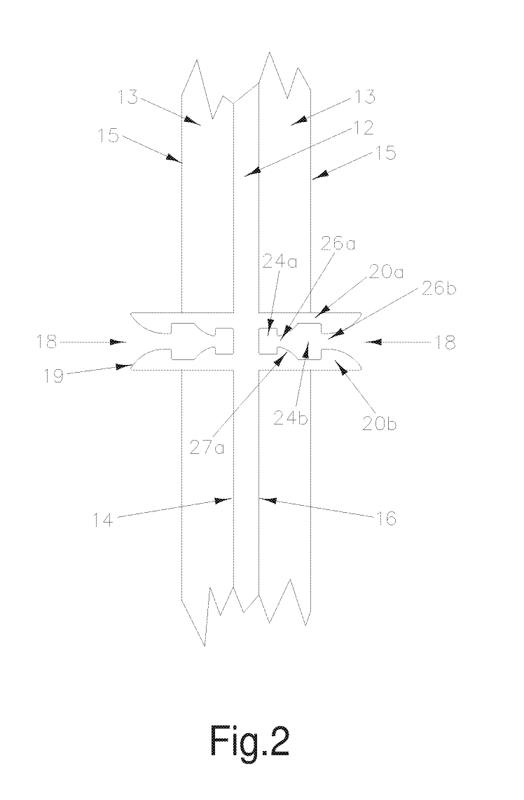

Shown in FIGS. 1, 1a, and 2, extending from each of the first face (14) and the second face (16) are a series of pairs of projections (20a, 20b). Each projection (20a, 20b) extends substantially across the width of the face (14, 16) on which it lies, perpendicular to the length (L) of the support member (12) (best shown in FIG. 1a). The space between each pair of projections (20a, 20b) forms a receiving groove (18) configured to receive a length of fencing wire in a tight or snap fit. The projections (20a, 20b) extend at least as far as the outside edge (15) of the reinforcing rib (13).

The receiving groove (18) may be one of a number of suitable configurations, the most important requirement being that it holds a length of fencing wire in a tight or snap fit. In the most preferred embodiment, as shown best in FIG. 2, the receiving groove (18) has curved or bevelled leading edges (19) on the outermost edges of the groove. This provides greater ease of fitting the wire during installation, as it leads the wire into the groove (18).

Within the receiving groove (18) are a first expanded section (24a) and a second expanded section (24b) separated by a first constricted section (26a). A second constricted section (26b) separates the second expanded section (24b) from the curved or bevelled leading edges (19). The first expanded section (24a) is configured to receive high tensile wire, and the first constricted section (26a) is configured to hold the high tensile wire in a snap fit within the first expanded section (24a). Preferably the first constricted section (26a) also has a curved or bevelled leading edge (27a) to aid in guiding the wire through the constricted section. The second expanded section (24b) is configured to receive number 8 wire, and the second constricted section (26b) is configured to hold the number 8 wire in a snap fit within the second expanded section (24b).

While this is the most preferred form of each receiving groove, many other configurations of receiving grooves are possible. The most preferred embodiment provides the advantage that a single fence spreader (10) can be manufactured and used as desired with either a high tensile fence (which is made from comparatively thin wire) or fence made from number 8 wire, as desired.

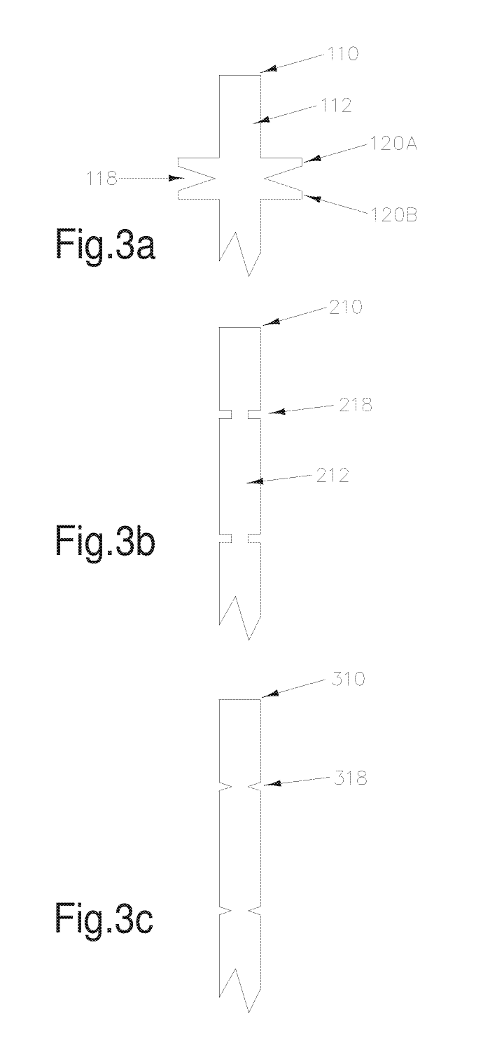

FIGS. 3a, 3b and 3c show various other possible configurations of receiving grooves. In one embodiment of the fence spreader (110), as shown in FIG. 3a, the receiving grooves (118) are formed from projections (120a, 120b), and the receiving grooves (118) are narrower closer to the support member (112), such that a wedge-shaped receiving groove (118) is formed. A wedge-shaped groove is advantageous, as several sizes of wire, including plain or barbed wire, can be accepted in a tight fit in the receiving groove (118), without the need to manufacture fence spreaders with different sized receiving grooves.

In a further embodiment of the fence spreader (210), shown in FIG. 3b, the receiving grooves (218) are formed as recesses in the support member (212) itself, rather than between projections. As shown in a further embodiment of the fence spreader (310) in FIG. 3c, the recessed receiving grooves (318) may also be wedge-shaped. The different configurations of the receiving grooves (18, 118, 218, 318) are not to be considered as limiting, and the receiving grooves may be formed in other configurations. It will also be appreciated that the receiving grooves are not limited to the previously mentioned types of wire. The receiving grooves may be configured to accommodate any fencing wire.

In the preferred embodiment receiving grooves (18) are located in pairs, one of the first face and one on the second face, along the length of the support member, as shown in FIG. 1. Having pairs of receiving grooves (18) in this manner allows for ease of use of the fence spreader. However, as only one receiving groove (18) of any one pair will be in use once the fence spreader is installed, it is also possible for only one of the faces of the support member to have a receiving groove (18), with each receiving groove (18) located on an opposite face to the immediately adjacent receiving grooves (18) (i.e. receiving grooves (18) are located on alternating faces of the support member (12) along the length of the support member (12)).

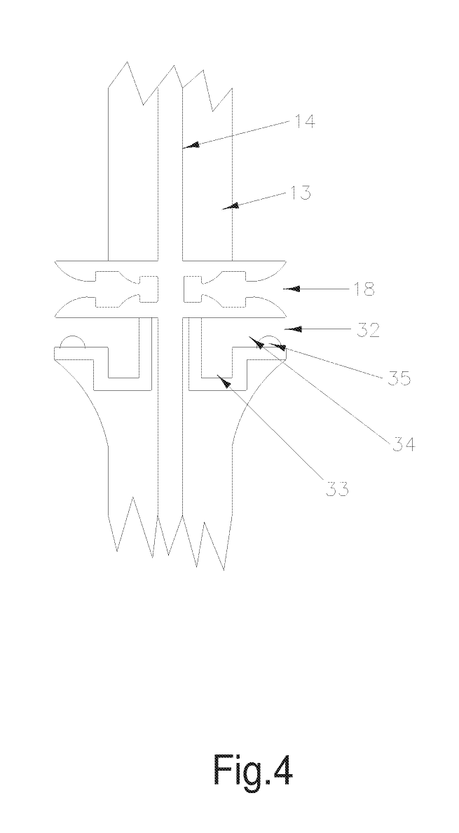

To allow for fences which include barbed wire, one or more secondary receiving grooves (32) may be provided, as shown in FIG. 4. Typically these will be located immediately below the topmost receiving groove, or in place of the topmost receiving groove, and/or immediately above or below, or instead of, the third from top receiving groove. FIG. 4 shows a secondary receiving groove (32) immediately below the third from top receiving groove (18). The secondary receiving grooves (32) are wider than receiving grooves (18), due to the larger diameter of the barbed wire strand. The secondary receiving grooves (32) preferably include a secondary expanded section (33) and a secondary constricted section (34), the secondary constricted section (34) including a dimple (35) that projects into the secondary constricted section (34) to aid in retaining the barbed wire.

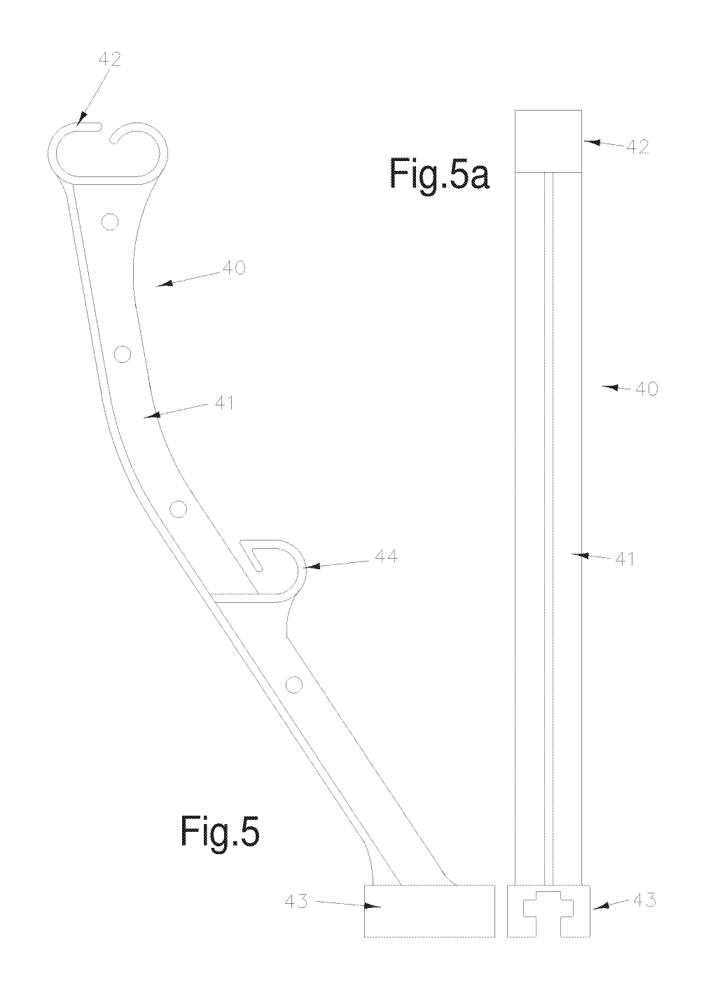

A preferred included feature is a detachable outrigger (40), as shown in FIG. 5. The outrigger (also known as a stand-off) allows an electrified tape, braid, or wire to be held offset from the fenceline. The outrigger (40) has an elongated portion (41) with a connecting portion (43) at one end and a first receiving portion (42) at the other end.

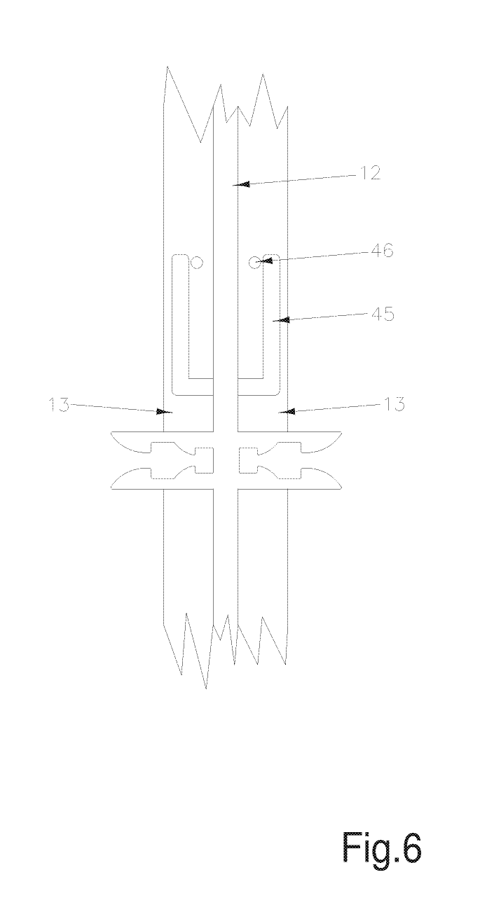

The connecting portion (43) connects to the support member (12) or reinforcing rib (13) of the fence spreader (10). Preferably, the connecting portion (43) is C-shaped in cross-section (as shown in FIG. 5a) and slides around the reinforcing rib (13), engaging with an L-shaped lug (45) on the reinforcing rib (13), which can be seen in FIG. 1 and in greater detail in FIG. 6. A dimple (46) adjacent the lug (45) allows the outrigger (40) to click into place. While this particular arrangement has been described, any connecting arrangement will suffice.

Alternatively, the outrigger (40) may be integrally formed with the support member (12), although this is not preferred. The ability to detach and attach the outrigger (40) is preferred as the installation of the fence spreader (10) requires threading the spreader (10) through fence wires, the fence often being high tensile. A detachable outrigger allows the outrigger to be attached after the spreader (10) has been installed on the fence. The ability to detach and attach the outrigger also means that the use of an outrigger is optional.

More preferably the outrigger curves up and away from the support (as seen in FIG. 5), and can be installed in two orientations (curving up and away from the support member, or curving down and away from the support member).

Optionally, part-way along the outrigger is a second receiving portion (44) to hold a length of electrifiable fencing material. The second receiving portion (44) is preferably a simple hook shape.

The outrigger and/or the first and/or second receiving portions are electrically insulated.

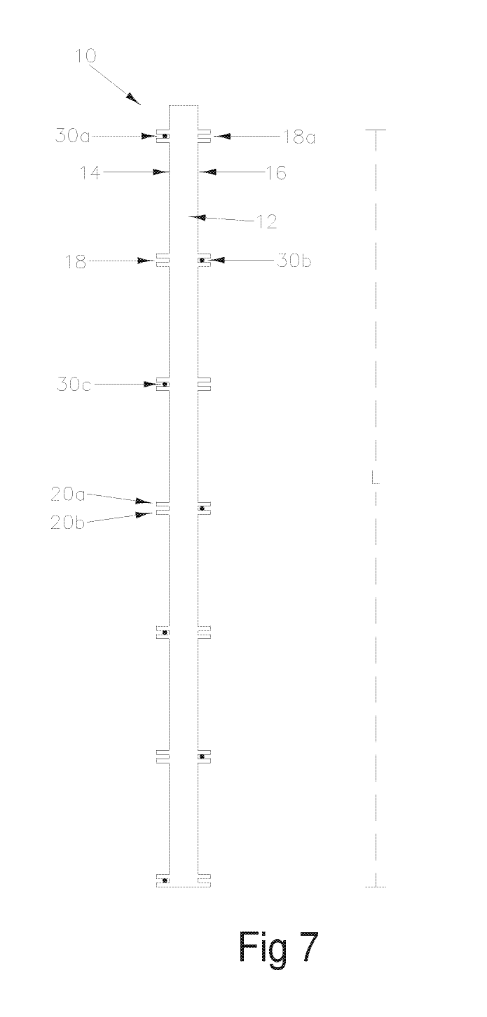

In use, the fence spreader (10) is inserted between the wires (30) of a wire fence, such that adjacent wires (30) are located on opposite sides of the support member (12). As shown in FIG. 7, if the topmost wire (30a) is located in a receiving groove (18) on the first face (14), the next wire (30b) down will be inserted into the appropriate receiving groove (18) on the second face (16). The third wire (30c) down will be inserted into a receiving groove (18) on the first face (14), and so on until all wires are located in receiving grooves (18).

The method of installing the fence spreader (10) for the preferred embodiment includes the steps of:
a) threading the fence spreader (10) through a wire fence such that adjacent fence wires (30) are positioned on opposite sides of the fence spreader and the length of the receiving grooves (18) are at 90° to the length of the fence wires.

That is, the fence spreader (10) is axially rotated 90° from its final installed position; then
b) twisting the fence spreader (10) axially such that each wire (30) is positioned, through the twisting motion, into a receiving groove (18) such that the wire (30) is held in a tight or snap fit. The bevelled leading edges (19) of each receiving groove (18) aids in drawing the wire (30) into its respective receiving groove (18).

As an optional step, after the wires (30) are positioned within the receiving grooves (18) an outrigger (40) may be connected to the fence spreader (10), and tape, braid, wire, or a similar electrifiable length of fencing material may be positioned within the first (42) or second (44) receiving portion of the or each outrigger (40).

The tension in the wires creates a force on the support member (12) from both sides of the support member (12), holding the fence spreader (10) in place on the fence. This method of installation is quick and simple, and does not require the use of clips or fasteners, and requires no tools. Unlike other designs, the wires on the fence do not require substantial manipulation to fit into the receiving grooves of the fence spreader; this is particularly important for high tensile fences. Furthermore, each fence spreader is comprised of a single component (with the exception of the optional outrigger), which allows for a simpler installation over previous designs, with no risk of missing or dropped parts.

While the support member (12) has been represented in the accompanying drawings as rectangular in cross-section, the support member (12) may be an elongated member of any cross-section, including circular. In the case where the support member (12) has a circular cross-section, the first (14) and second (16) faces are opposite sides of the support member (12), i.e. where the tangents are parallel. The reinforcing rib (13) is preferred, but not essential.

Where the receiving grooves (18, 118) are formed between pairs of projections (20a, 20b), the projections may be integrally formed with the support member (12), or separate components attached by any suitable means.

If the spreader is to be used with non-electrified fences, the spreader may be made of any suitable material, for example metal or plastics material.

If the spreader is to be used with an electrified fence, then it must be capable of insulating the wires from each other. This can be achieved by making the whole of the spreader from an electrically insulating material (e.g. fibreglass, plastics material, preferably HDPE) or making one or more of the projections (20a, 20b) or receiving grooves (18) of electrically insulating material.

What is claimed is:

1-29. (canceled)

30. A fence spreader comprising:
an elongated support member having a first face and a second face, wherein the first face and the second face are located on opposite sides of the support member;
a plurality of receiving grooves across each said first and second faces and spaced along the length of the support member, each receiving groove is formed as a recess in the first or second face;
wherein each receiving groove is configured to hold a fence wire in a snap fit configuration of
wherein each receiving groove is configured such that a length of wire may be held in an expanded section by a constricted section; and
wherein the receiving grooves are configured such that, in use, adjacent fence wires are positioned on opposite sides of the fence spreader.

31. The fence spreader as claimed in claim 30, wherein each receiving groove is located on an opposite face to immediately adjacent receiving grooves.

32. The fence spreader as claimed in claim 30, wherein receiving grooves are located in pairs, one on the first face and one on the second face, along the length of the support member.

33. The fence spreader as claimed in claim 30, wherein each receiving groove is configured to receive more than one diameter of wire.

34. The fence spreader as claimed in claim 30, wherein the fence spreader is constructed from an electrically insulating material.

35. The fence spreader as claimed in claim 34, wherein the fence spreader is constructed from high-density polyethylene.

36. An outrigger that connects to a fence post or fence spreader comprising an elongated portion with:
a connecting portion at one end that connects the outrigger to a fence spreader about a rib on the fence spreader; and
a first receiving portion at the other end that allows fencing material to be held offset from the fence line.

37. The outrigger as claimed in claim 36 wherein the connecting portion of the outrigger slides around the rib on the fencer spreader.

38. The outrigger as claimed in claim 36 wherein the connecting portion of the outrigger is C-shaped in cross-section and engages an L-shaped lug on the fence spreader rib.

39. The outrigger as claimed in claim 36 wherein the outrigger curves up and away from the fence spreader.

40. The outrigger as claimed in claim 36 wherein the outrigger curves down and away from the fence spreader.

41. The outrigger as claimed in claim 36, wherein the outrigger further includes a receiving portion part way along the elongated portion.

42. The outrigger as claimed in claim 36, wherein the outrigger is detachable from the fence post or fence spreader.

43. The outrigger as claimed in claim 36, wherein the outrigger is constructed from electrically insulating material.

44. The outrigger as claimed in claim 7 wherein the fencing material is an electrified tape, braid, or wire.

45. A fence spreader system comprising:
a fence spreader having
an elongated support member having a first face and a second face, wherein the first face and the second face are located on opposite sides of the support member;
a plurality of receiving grooves across each said first and second faces and spaced along the length of the support member, each receiving groove is formed as a recess in the first or second face;
wherein each receiving groove is configured to hold a fence wire in a snap fit configuration or wherein each receiving groove is configured such that a length of wire may be held in an expanded section by a constricted section; and
wherein the receiving grooves are configured such that, in use, adjacent fence wires are positioned on opposite sides of the fence spreader;
an outrigger that connects to a fence post or fence spreader comprising an elongated portion with
a connecting portion at one end that connects the outrigger to a fence spreader about a rib on the fence spreader; and
a first receiving portion at the other end that allows fencing material to be held offset from the fence line.
